(19) United States
(12) Patent Application Publication
(10) Pub. No.: US 2006/0075211 A1
(43) Pub. Date: Apr. 6, 2006

(54) Method and device for data processing

(76) Inventor: Martin Vorbach, Munich (DE)

Correspondence Address: KENYON & KENYON LLP, ONE BROADWAY, NEW YORK, NY, 10004, US

(21) Appl. No.: 10/508,559

(22) PCT Filed: Mar. 21, 2003
(86) PCT No.: PCT/DE03/00942

§ 371 Date: Jun. 20, 2005

(30) Foreign Application Priority Data
Mar. 21, 2002 (DE) 102 12 622.4
Mar. 21, 2002 (DE) 102 12 621.6
May 2, 2002 (DE) 102 19 681.8
May 2, 2002 (EP) 02 009 868.7
Jun. 12, 2002 (DE) 102 26 186.5
Jun. 20, 2002 (DE) 102 27 650.1
Jun. 20, 2002 (EP) EP02/06865
Aug. 7, 2002 (DE) 102 36 271.8
Aug. 7, 2002 (DE) 102 36 272.6
Aug. 7, 2002 (DE) 102 36 269.6
Aug. 16, 2002 (EP) EP02/10065
Aug. 21, 2002 (DE) 102 38 174.7
Aug. 21, 2002 (DE) 102 38 173.9
Aug. 21, 2002 (DE) 102 38 172.0
Aug. 27, 2002 (DE) 102 40 022.9
Aug. 27, 2002 (DE) 102 40 000.8
Sep. 3, 2002 (DE) DE02/03278
Sep. 6, 2002 (DE) 102 41 812.8
Sep. 18, 2002 (EP) EP02/10479
Sep. 18, 2002 (EP) EP02/10464
Sep. 19, 2002 (EP) EP02/10572
Oct. 10, 2002 (EP) 02 022 692.4
Dec. 6, 2002 (EP) 02 027 277.9
Jan. 7, 2003 (DE) 103 00 380.0
Jan. 20, 2003 (EP) EP03/00624
Jan. 20, 2003 (DE) DE03/00152
Feb. 18, 2003 (DE) DE03/00489

(51) Int. Cl. G06F 9/44

(52) U.S. Cl. 712/221

(57) ABSTRACT

Designing a coupling of a traditional processor, in particular a sequential processor, and a reconfigurable field of data processing units, in particular a runtime-reconfigurable field of data processing units is described.

The present invention relates to the integration and/or snug coupling of reconfigurable processors with standard processors, data exchange and synchronization of data processing as well as compilers for them.

A reconfigurable architecture in the present context is understood to refer to modules or units (VPUs) having a configurable function and/or interconnection, in particular integrated modules having a plurality of arithmetic and/or logic and/or analog and/or memory and/or internal/external interconnecting modules in one or more dimensions interconnected directly or via a bus system.

The generic type of such modules includes in particular systolic arrays, neural networks, multiprocessor systems, processors having a plurality of arithmetic units and/or logic cells and/or communicative/peripheral cells (IO), interconnection and network modules such as crossbar switches; likewise, known modules of the generic types FPGA, DPGA, Chameleon, XPUTER, etc. Reference is made in this connection in particular to the following patents and patent applications by the same applicant: P 44 16 881 A1, DE 197 81 412 A1, DE 197 81 483 A1, DE 196 54 846 A1, DE 196 54 593 A1, DE 197 04 044.6 A1, DE 198 80 129 A1, DE 198 61 088 A1, DE 199 80 312 A1, PCT/DE 00/01869, DE 100 36 627 A1, DE 100 28 397 A1, DE 101 10 530 A1, DE 101 11 014 A1, PCT/EP 00/10516, EP 01 102 674 A1, DE 198 80 128 A1, DE 101 39 170 A1, DE 198 09 640 A1, DE 199 26 538.0 A1, DE 100 50 442 A1, PCT/EP 02/02398, DE 102 40 000, DE 102 02 044, DE 102 02 175, DE 101 29 237, DE 101 42 904, DE 101 35 210, EP 01 129 923, PCT/EP 02/10084, DE 102 12 622, DE 102 36 271, DE 102 12 621, EP 02 009 868, DE 102 36 272, DE 102 41 812, DE 102 36 269, DE 102 43 322, EP 02 022 692, DE 103 00 380, DE 103 10 195 and EP 02 001 331 and EP 02 027 277. The full content of these documents is herewith incorporated for disclosure purposes.

The architecture mentioned above is used as an example for clarification and is referred to below as a VPU. This architecture is composed of any, typically coarsely granular arithmetic, logic cells (including memories) and/or memory cells and/or interconnection cells and/or communicative/peripheral (IO) cells (PAEs) which may be arranged in a one-dimensional or multi-dimensional matrix (PA). The matrix may have different cells of any design; the bus systems are also understood to be cells here. A configuration unit (CT) which stipulates the interconnection and function of the PA through configuration is assigned to the matrix as a whole or parts thereof. A finely granular control logic may be provided.

Various methods are known for coupling reconfigurable processors with standard processors. They usually involve a loose coupling. In many regards, the type and manner of coupling still need further improvement; the same is true for compiler methods and/or operating methods provided for joint execution of programs on combinations of reconfigurable processors and standard processors.

The object of the present invention is to provide a novel approach for commercial use.

The means of achieving this object are claimed independently. Preferred embodiments are to be found in the subclaims.

### DESCRIPTION OF THE INVENTION

A standard processor, e.g., an RISC, CISC, DSP (CPU), is connected to a reconfigurable processor (VPU). Two different, but preferably simultaneously implemented and/or implementable coupling variants are described.

A first variant has a direct coupling to the instruction set of a CPU (instruction set coupling).

A second variant has a coupling via tables in the main memory.

The two variants are simultaneously and/or alternatively implementable.

Instruction Set Coupling

Free unused instructions are usually available within an instruction set (ISA) of a CPU. One or a plurality of these free unused instructions is now used for controlling VPUs (VPUCODE).

By decoding a VPUCODE, a configuration unit (CT) of a VPU is triggered, executing certain sequences as a function of the VPUCODE.

For example, a VPUCODE may trigger the loading and/or execution of configurations by the configuration unit (CT) for a VPU.

Command Transfer to the VPU

In an expanded embodiment, a VPUCODE may be translated into various VPU commands via an address mapping table, which is preferably constructed by the CPU. The configuration table may be set as a function of the CPU program or code segment executed.

After the arrival of a load command, the VPU loads configurations from a separate memory or a memory shared with the CPU, for example. In particular, a configuration may be contained in the code of the program currently being executed.

After receiving an execution command, a VPU will execute the configuration to be executed and will perform the corresponding data processing. The termination of data processing may be displayed on the CPU by a termination signal (TERM).

VPUCODE Processing on the CPU

When a VPUCODE occurs, wait cycles may be executed on the CPU until the termination signal (TERM) for termination of data processing by the VPU arrives.

In a preferred embodiment, processing is continued by processing the next code. If there is another VPUCODE, processing may then wait for the termination of the preceding code, or all VPUCODEs started are queued into a processing pipeline, or a task change is executed as described below.

Termination of data processing is signaled by the arrival of the termination signal (TERM) in a status register. The termination signals arrive in the sequence of a possible processing pipeline. Data processing on the CPU may be synchronized by checking the status register for the arrival of a termination signal.

In one possible embodiment, if an application cannot be continued before the arrival of TERM, e.g., due to data dependencies, a task change may be triggered.

Coupling of Coprocessors (Loose Coupling)

According to DE 101 10 530, preferably loose couplings, in which the VPUs work largely as independent coprocessors, are established between processors and VPUs.

Such coupling typically involves one or more common data sources and data sinks, usually via common bus systems and/or shared memories. Data is exchanged between a CPU and a VPU via DMAs and/or other memory access controllers. Data processing is synchronized preferably via an interrupt control or a status query mechanism (e.g., polling).

Coupling of Arithmetic Units (Snug Coupling)

A snug coupling corresponds to a direct coupling of a VPU into the instruction set of a CPU as described above.

In a direct coupling of an arithmetic unit, a high reconfiguration performance in particular is important. Therefore the wave reconfiguration according to DE 198 07 872, DE 199 26 538, DE 100 28 397 may preferably be used. In addition, the configuration words are preferably preloaded in advance according to DE 196 54 846, DE 199 26 538, DE 100 28 397, DE 102 12 621 so that on execution of the instruction, the configuration may be configured particularly rapidly (e.g., by wave reconfiguration in the optimum case within one clock pulse).

For the wave reconfiguration, preferably the presumed configurations to be executed are recognized in advance, i.e., estimated and/or predicted, by the compiler at the compile time and preloaded accordingly at the runtime as far as possible. Possible methods are described, for example, in DE 196 54 846, DE 197 04 728, DE 198 07 872, DE 199 26 538, DE 100 28 397, DE 102 12 621.

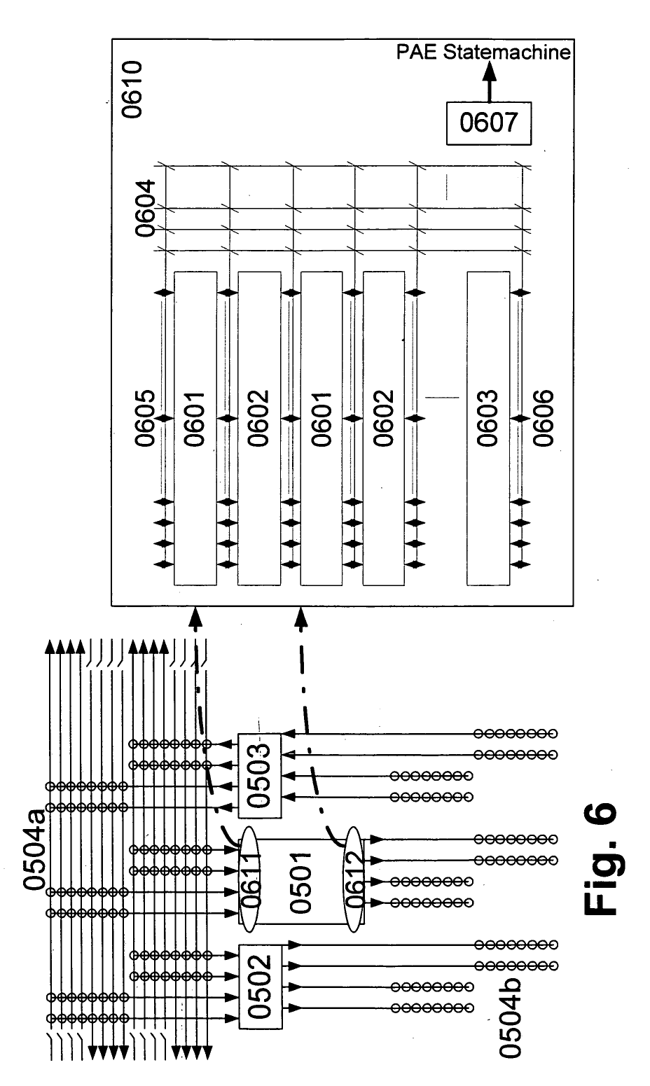

At the point in time of execution of the instruction, the configuration or a corresponding configuration is selected and executed. Such methods are known according to the publications cited above. Preloading of configurations into shadow configuration registers is particularly preferred, as is known, for example, from DE 197 04 728 (FIG. 6) and DE 102 12 621 (FIG. 14) in order to then be available particularly rapidly on retrieval.

Data Transfers

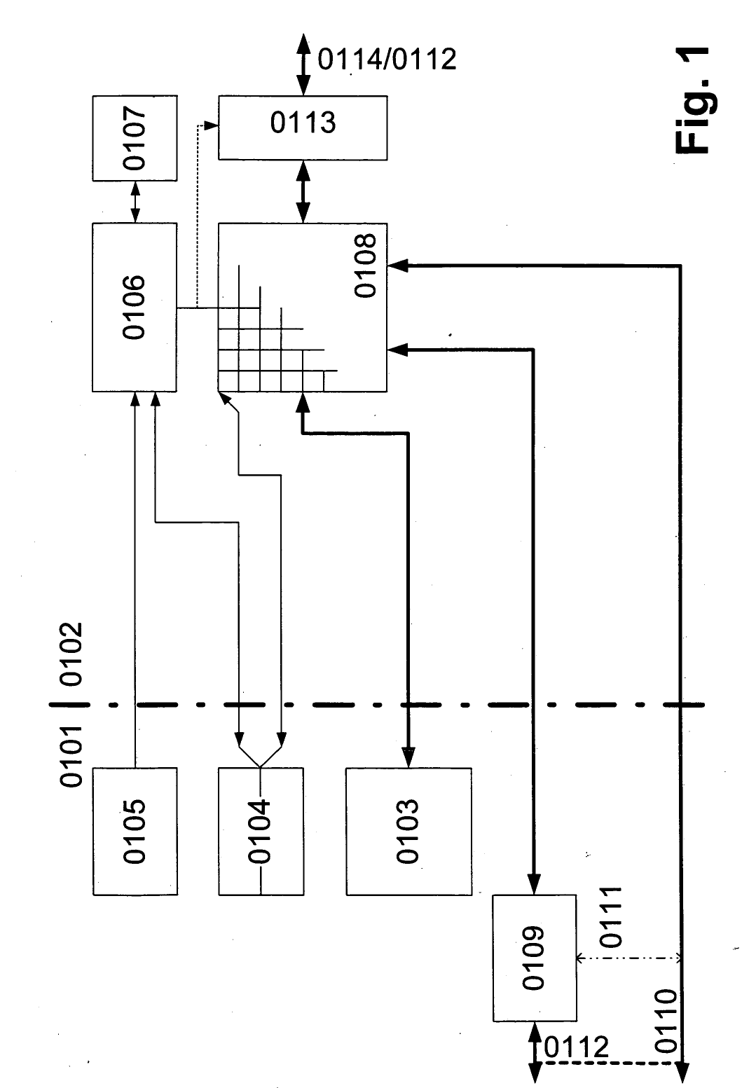

One possible implementation, e.g., as shown in FIG. 1, may involve different data transfers between a CPU (0101) and VPU (0102). Configurations to be executed on the VPU are selected by the instruction decoder (0105) of the CPU, which recognizes certain instructions intended for the VPU and triggers the CT (0106) so the CT loads into the array of PAEs (PA, 0108) the corresponding configurations from a memory (0107) which is assigned to the CT and may be in particular shared with the CPU or the same as the working memory of the CPU.

It should be pointed out explicitly that for reasons of simplicity, only the relevant components (in particular the CPU) are shown in FIG. 1, but a substantial number of other components and networks are present.

Three methods that may be used, particularly preferably individually or in combination, are described below.

Registers

In a register coupling, the VPU may obtain data from a CPU register (0103), process it and write it back to a CPU register or the CPU register.

Synchronization mechanisms are preferably used between the CPU and the VPU.

For example, the VPU may receive an RDY signal (DE 196 51 075, DE 110 10 530) due to the fact that data is written into a CPU register by the CPU and then the data written in may be processed. Readout of data from a CPU register by the CPU may generate an ACK signal (DE 196 51 075, DE 110 10 530), so that data retrieval by the CPU is signaled to the VPU. CPUs typically do not provide any corresponding mechanisms.

Two possible approaches are described in greater detail here.

One approach which is simple to implement is to have data synchronization performed via a status register (0104). For example, the VPU may display in the status register successful readout of data from a register and the ACK signal associated with it (DE 196 51 075, DE 110 10 530) and/or writing of data into a register and the associated RDY signal (DE 196 51 075, DE 110 10 530). The CPU will first check the status register and will execute waiting loops or task changes, for example, until the RDY or ACK signal has arrived, depending on the operation. Then the CPU executes the particular register data transfer.

In an expanded embodiment, the instruction set of the CPU is expanded by load/store instructions having an integrated status query (load_rdy, store_ack). For example, for a store_ack, a new data word is written into a CPU register only when the register has previously been read out by the CPU and an ACK has arrived. Accordingly, load_rdy reads data out of a CPU register only when the VPU has previously written in new data and generated an RDY.

Data belonging to a configuration to be executed may be written into or read out of the CPU registers successively, more or less through block moves according to the related art. Block move instructions implemented, if necessary, may preferably be expanded through the integrated RDY/ACK status query described above.

In an additional or alternative variant, data processing within the VPUs connected to the CPU requires exactly the same number of clock pulses as does data processing in the computation pipeline of the CPU. This concept may be used ideally in modern high-performance CPUs having a plurality of pipeline stages (>20) in particular. The particular advantage is that no special synchronization mechanisms such as RDY/ACK are necessary. In this procedure, the compiler need only ensure that the VPU maintains the required number of clock pulses and, if necessary, balance out the data processing, e.g., by inserting delay stages such as registers and/or the fall-through FIFOs known from DE 110 10 530, FIGS. 9/10.

Another variant permits a different runtime characteristic between the data path of the CPU and the VPU. To do so, the compiler preferably first re-sorts the data accesses to achieve at least essentially maximal independence between the accesses through the data path of the CPU and the VPU. The maximum distance thus defines the maximum runtime difference between the CPU data path and the VPU. In other words, preferably through a reordering method such as that known per se from the related art, the runtime difference between the CPU data path and the VPU data path is equalized. If the runtime difference is too great to be compensated by re-sorting the data accesses, then NOP cycles (i.e., cycles in which the CPU data path is not processing any data) may be inserted by the compiler and/or wait cycles may be generated in the CPU data path by the hardware until the required data has been written from the VPU into the register. The registers may therefore be provided with an additional bit which indicates the presence of valid data.

It is apparent that a variety of simple modifications and of different embodiments of these basic methods is possible.

The wave reconfiguration mentioned above, in particular also preloading of configurations into shadow configuration registers, allows successive starting of a new VPU instruction and the corresponding configuration as soon as the operands of the preceding VPU instruction have been removed from the CPU registers. The operands for the new instruction may be written to the CPU registers immediately after the start of the instruction. According to the wave reconfiguration method, the VPU is reconfigured successively for the new VPU instruction on completion of data processing of the previous VPU instruction and the new operands are processed.

Bus Accesses

In addition, data may be exchanged between a VPU and a CPU via suitable bus accesses on common resources.

Cache

If there is to be an exchange of data that has been processed recently by the CPU and is therefore presumably still in the cache (0109) of the CPU and/or is processed immediately thereafter by the CPU and therefore would logically still be in the cache of the CPU, it is read out of the cache of the CPU and/or written into the cache of the CPU preferably by the VPU. This may be ascertained by the compiler largely in advance of the compile time of the application through suitable analyses, and the binary code may be generated accordingly.

Bus

If there is to be an exchange of data that is presumably not in the cache of the CPU and/or will presumably not be needed subsequently in the cache of the CPU, this data is read directly from the external bus (0110) and the associated data source (e.g., memory, peripherals) and/or written to the external bus and the associated data sink (e.g., memory, peripherals) preferably by the VPU. This bus may be in particular the same as the external bus of the CPU (0112 and dashed line). This may be ascertained by the compiler largely in advance of the compile time of the application through suitable analyses, and the binary code may be generated accordingly.

In a transfer over the bus, bypassing the cache, a protocol (0111) is preferably implemented between the cache and the bus, ensuring correct contents of the cache. For example, the MESI protocol from the related art which is known per se may be used for this purpose.

Cache/RAM-PAE Coupling

A particularly preferred method is to have a snug coupling of RAM-PAEs to the cache of the CPU. Data may thus be transferred rapidly and efficiently between the memory databus and/or IO databus and the VPU. The external data transfer is largely performed automatically by the cache controller.

This method allows rapid and uncomplicated data exchange in task change procedures in particular, for realtime applications and multithreading CPUs with a change of threads.

Two basic methods are available:

a) RAM-PAE/Cache Coupling

The RAM-PAE transmits data, e.g., for reading and/or writing of external data and in particular main memory data directly to and/or from the cache. Preferably a separate databus may be used according to DE 196 54 595 and DE 199 26 538. Then, independently of data processing within the VPU and in particular also via automatic control, e.g., by independent address generators, data may then be transferred to or from the cache via this separate databus.

b) RAM-PAE as a Cache Slice

In a particularly preferred embodiment, the RAM-PAEs do not have any internal memory but instead are coupled directly to blocks (slices) of the cache. In other words, the RAM-PAEs have only the bus triggers for the local buses plus optional state machines and/or optional address generators, but the memory is within a cache memory bank to which the RAM-PAE has direct access. Each RAM-PAE has its own slice within the cache and may access the cache and/or its own slice independently and in particular simultaneously with the other RAM-PAEs and/or the CPU. This may be implemented simply by constructing the cache of multiple independent banks (slices).

If the content of a cache slice has been modified by the VPU, it is preferably marked as “dirty,” whereupon the cache controller automatically writes this back to the external memory and/or main memory.

For many applications, a write-through strategy may additionally be implemented or selected. In this strategy, data newly written by the VPU into the RAM-PAEs is directly written back to the external memory and/or main memory with each write operation. This additionally eliminates the need for labeling data as “dirty” and writing it back to the external memory and/or main memory with a task change and/or thread change.

In both cases, it may be expedient to block certain cache regions for access by the CPU for the RAM-PAE/cache coupling.

An FPGA (0113) may be coupled to the architecture described here, in particular directly to the VPU, to permit finely granular data processing and/or a flexible adaptable interface (0114) (e.g., various serial interfaces (V24, USB, etc.), various parallel interfaces, hard drive interfaces, Ethernet, telecommunications interfaces (a/b, T0, ISDN, DSL, etc.)) to other modules and/or the external bus system (0112). The FPGA may be configured from the VPU architecture, in particular by the CT, and/or by the CPU. The FPGA may be operated statically, i.e., without reconfiguration at runtime and/or dynamically, i.e., with reconfiguration at runtime.

FPGAs in ALUs

FPGA elements may be included in a “processor-oriented” embodiment within an ALU-PAE. To do so, an FPGA data path may be coupled in parallel to the ALU or in a preferred embodiment, connected upstream or downstream from the ALU.

Within algorithms written in the high-level languages such as C, bit-oriented operations usually occur very sporadically and are not particularly complex. Therefore, an FPGA structure of a few rows of logic elements, each interlinked by a row of wiring troughs, is sufficient. Such a structure may be easily and inexpensively programmably linked to the ALU. One essential advantage of the programming methods described below may be that the runtime is limited by the FPGA structure, so that the runtime characteristic of the ALU is not affected. Registers need only be allowed for storage of data for them to be included as operands in the processing cycle taking place in the next clock pulse.

It is particularly advantageous to implement optionally additionally configurable registers to establish a sequential characteristic of the function through pipelining, for example. This is advantageous in particular when feedback occurs in the code for the FPGA structure. The compiler may then map this by activation of such registers per configuration and may thus correctly map sequential code. The state machine of the PAE which controls its processing is notified of the number of registers added per configuration so that it may coordinate its control, in particular also the PAE-external data transfer, to the increased latency time.

An FPGA structure which is automatically switched to neutral in the absence of configuration, e.g., after a reset, i.e., passing the input data through without any modification, is particularly advantageous. Thus if FPGA structures are not used, no configuration data is needed to set them, thus eliminating configuration time and configuration data space in the configuration memories.

Operating System Mechanisms

The methods described here do not at first provide any particular mechanism for operating system support. In other words, it is preferable to ensure that an operating system to be executed behaves according to the status of a VPU to be supported. Schedulers are needed in particular.

In a snug arithmetic unit coupling, it is preferable to query the status register of the CPU into which the coupled VPU has entered its data processing status (termination signal). If additional data processing is to be transferred to the VPU, and if the VPU has not yet terminated the prior data processing, the system waits or preferably a task change is implemented.

Sequence control of a VPU may essentially be performed directly by a program executed on the CPU, representing more or less the main program which swaps out certain subprograms with the VPU.

For a coprocessor coupling, mechanisms which are preferably controlled by the operating system, in particular the scheduler, are used, whereby the sequence control of a VPU may essentially be performed directly by a program executed on the CPU, representing more or less the main program which swaps out certain subprograms with the VPU.

After transfer of a function to a VPU, a simple scheduler
1. may have the current main program continue to run on the CPU if it is able to run independently and in parallel with the data processing on a VPU;
2. if or as soon as the main program must wait for the end of data processing on the VPU, the task scheduler switches to a different task (e.g., another main program). The VPU may continue processing in the background regardless of the current CPU task.

Each newly activated task must check before use (if it uses the VPU) to determine whether the VPU is available for data processing or is still currently processing data. In the latter case, it must either wait for the end of data processing or preferably a task change is implemented.

A simple and nevertheless efficient method may be based on descriptor tables, which may be implemented as follows, for example:

On calling the VPU, each task generates one or more tables (VPUPROC) having a suitable defined data format in the memory area assigned to it. This table includes all the control information for a VPU such as the program/configuration(s) to be executed (or the pointer(s) to the corresponding memory locations) and/or memory location(s) (or the pointer(s) thereto) and/or data sources (or the pointer(s) thereto) of the input data and/or the memory location(s) (or the pointer(s) thereto) of the operands or the result data.

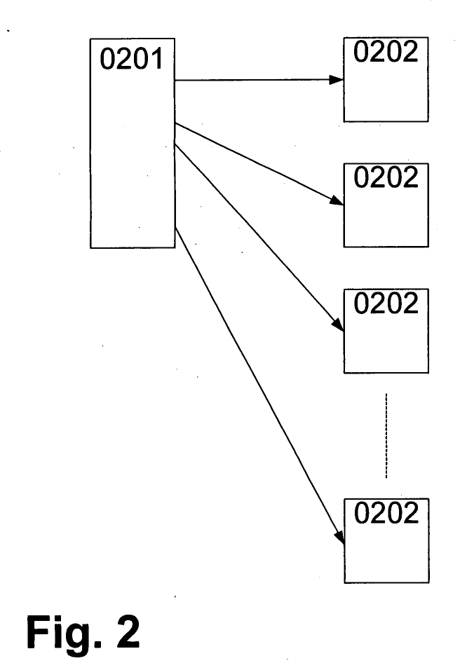

According to FIG. 2, a table or an interlinked list (LINKLIST, 0201), for example, in the memory area of the operating system points to all VPUPROC tables (0202) in the order in which they are created and/or called.

Data processing on the VPU now proceeds by a main program creating a VPUPROC and calling the VPU via the operating system. The operating system then creates an entry in the LINKLIST. The VPU processes the LINKLIST and executes the VPUPROC referenced. The end of a particular data processing run is indicated through a corresponding entry into the LINKLIST and/or VPUCALL table. Alternatively, interrupts from the VPU to the CPU may also be used as an indication and also for exchanging the VPU status, if necessary.

In this method, which is preferred according to the present invention, the VPU functions largely independently of the CPU. In particular, the CPU and the VPU may perform independent and different tasks per unit of time. The operating system and/or the particular task must merely monitor the tables (LINKLIST and/or VPUPROC).

Alternatively, the LINKLIST may also be omitted by interlinking the VPUPROCs together by pointers as is known from lists, for example. Processed VPUPROCs are removed from the list and new ones are inserted into the list. This method is familiar to programmers and therefore need not be explained further here.

Multithreading/Hyperthreading

It is particularly advantageous to use multithreading and/or hyperthreading technologies in which a scheduler (preferably implemented in hardware) distributes finely granular applications and/or application parts (threads) among resources within the processor. The VPU data path is regarded as a resource for the scheduler. A clean separation of the CPU data path and the VPU data path is already given by definition due to the implementation of multithreading and/or hyperthreading technologies in the compiler. In addition, there is the advantage that when the VPU resource is occupied, it is possible to simply change within one task to another task and thus achieve better utilization of resources. At the same time, parallel utilization of the CPU data path and VPU data path is also facilitated.

To this extent, multithreading and/or hyperthreading constitutes a method to be preferred in comparison with the LINKLIST described above.

The two methods operate in a particularly efficient manner with regard to performance if an architecture that allows reconfiguration superimposed with data processing is used as the VPU, e.g., the wave reconfiguration according to DE 198 07 872, DE 199 26 538, DE 100 28 397.

It is thus possible to start a new data processing run and any reconfiguration associated with it immediately after reading the last operands out of the data sources. In other words, the end of data processing is no longer necessary for synchronization but instead reading of the last operands is required. This greatly increases the performance of data processing.

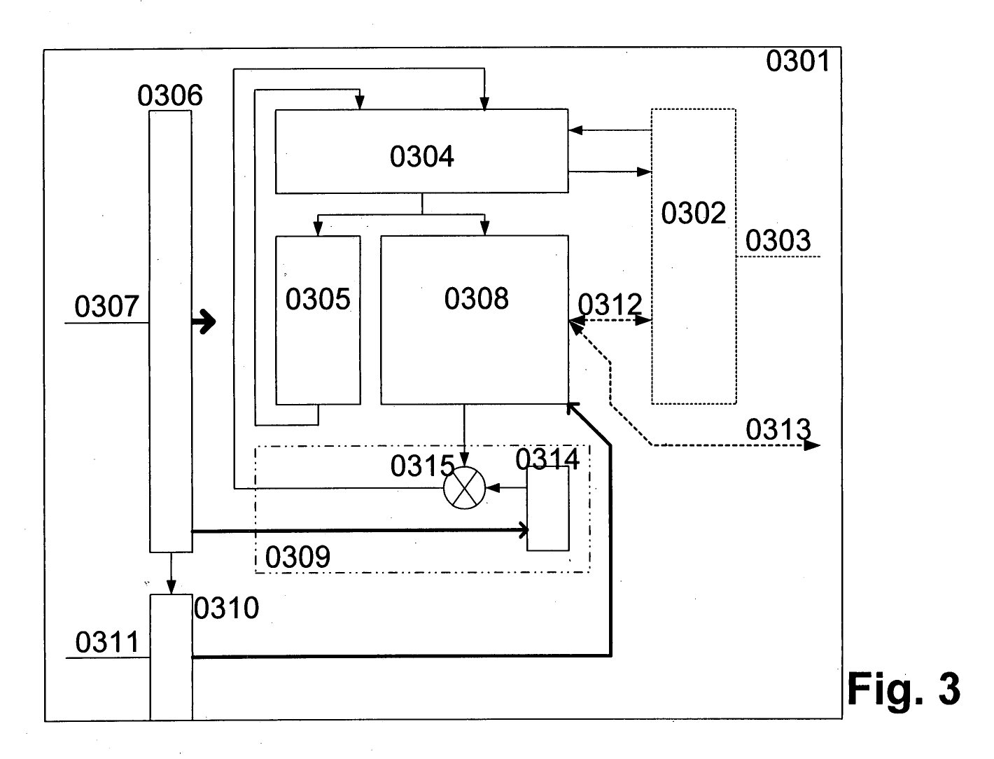

FIG. 3 shows a possible internal structure of a microprocessor or microcontroller. This shows the core (0301) of a microcontroller or microprocessor. The exemplary structure also includes a load/store unit for transferring data between the core and the external memory and/or the peripherals. The transfer takes place via interface 0303 to which additional units such as MMUs, caches, etc. may be connected.

In a processor architecture according to the related art, the load/store unit transfers the data to or from a register set (0304) which then stores the data temporarily for further internal processing. Further internal processing takes place on one or more data paths, which may be designed identically or differently (0305). There may also be in particular multiple register sets, which may in turn be coupled to different data paths, if necessary (e.g., integer data paths, floating-point data paths, DSP data paths/multiply-accumulate units).

Data paths typically take operands from the register unit and write the results back to the register unit after data processing. An instruction loading unit (opcode fetcher, 0306) assigned to the core (or contained in the core) loads the program code instructions from the program memory, translates them and then triggers the necessary work steps within the core. The instructions are retrieved via an interface (0307) to a code memory with MMUs, caches, etc., connected in between, if necessary.

The VPU data path (0308) parallel to data path 0305 has reading access to register set 0304 and has writing access to the data register allocation unit (0309) described below. The construction of a VPU data path is described, for example, in DE 196 51 075, DE 100 50 442, DE 102 06 653 and several publications by the present applicant.

The VPU data path is configured via the configuration manager (CT) 0310 which loads the configurations from an external memory via a bus 0311. Bus 0311 may be identical to 0307, and one or more caches may be connected between 0311 and 0307 and/or the memory, depending on the design.

The configuration that is to be configured and executed at a certain point in time is defined by opcode fetcher 0306 using special opcodes. Therefore, a number of possible configurations may be allocated to a number of opcodes reserved for the VPU data path. The allocation may be performed via a reprogrammable lookup table (see 0106) upstream from 0310 so that the allocation is freely programmable and is variable within the application.

In one embodiment which is possible, depending on the application, the destination register of the data computation may be managed in the data register allocation unit (0309) on calling a VPU data path configuration. The destination register defined by the opcode is therefore loaded into a memory, i.e., register (0314), which may be designed as a FIFO—in order to allow multiple VPU data path calls in direct succession and without taking into account the processing time of the particular configuration. As soon as one configuration supplies the result data, it is linked (0315) to the particular allocated register address and the corresponding register is selected and written to 0304.

A plurality of VPU data path calls may thus be performed in direct succession and in particular with overlap. One need only ensure, e.g., by compiler or hardware, that the operands and result data are re-sorted with respect to the data processing in data path 0305, so that there is no interference due to different runtimes in 0305 and 0308.

If the memory and/or FIFO 0314 is full, processing of any new configuration for 0308 is delayed. Reasonably, 0314 may hold as much register data as 0308 is able to hold configurations in a stack (see DE 197 04 728, DE 100 28 397, DE 102 12 621). In addition to management by the compiler, the data accesses to register set 0304 may also be controlled via memory 0314.

If there is an access to a register that is entered into 0314, it may be delayed until the register has been written and its address has been removed from 0314.

Alternatively and preferably, the simple synchronization methods according to 0103 may be used, a synchronous data reception register optionally being provided in register set 0304; reading access to this data reception register is possible only if VPU data path 0308 has previously written new data to the register. Conversely, data may be written by the VPU data path only if the previous data has been read. To this extent, 0309 may be omitted without replacement.

When a VPU data path configuration that has already been configured is called, there is no longer any reconfiguration. Data is transferred immediately from register set 0304 to the VPU data path for processing and is then processed. The configuration manager saves the configuration code number currently loaded in a register and compares it with the configuration code number that is to be loaded and that is transferred to 0310 via a lookup table (see 0106), for example. The called configuration is reconfigured only if the numbers do not match.

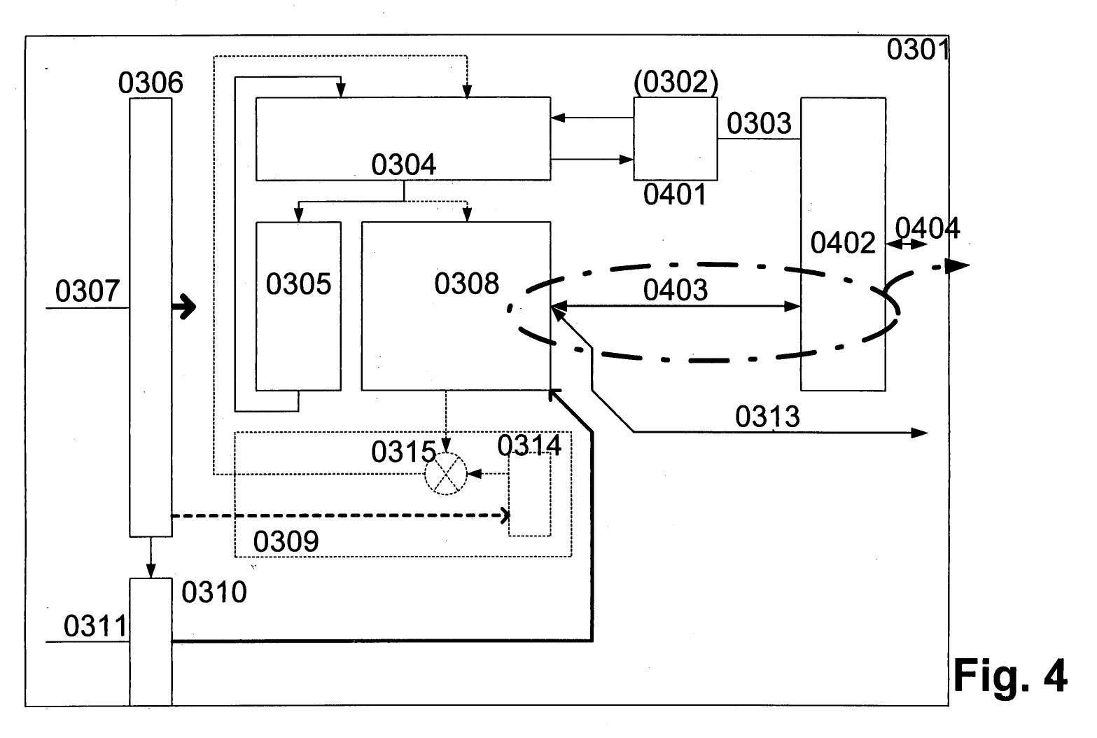

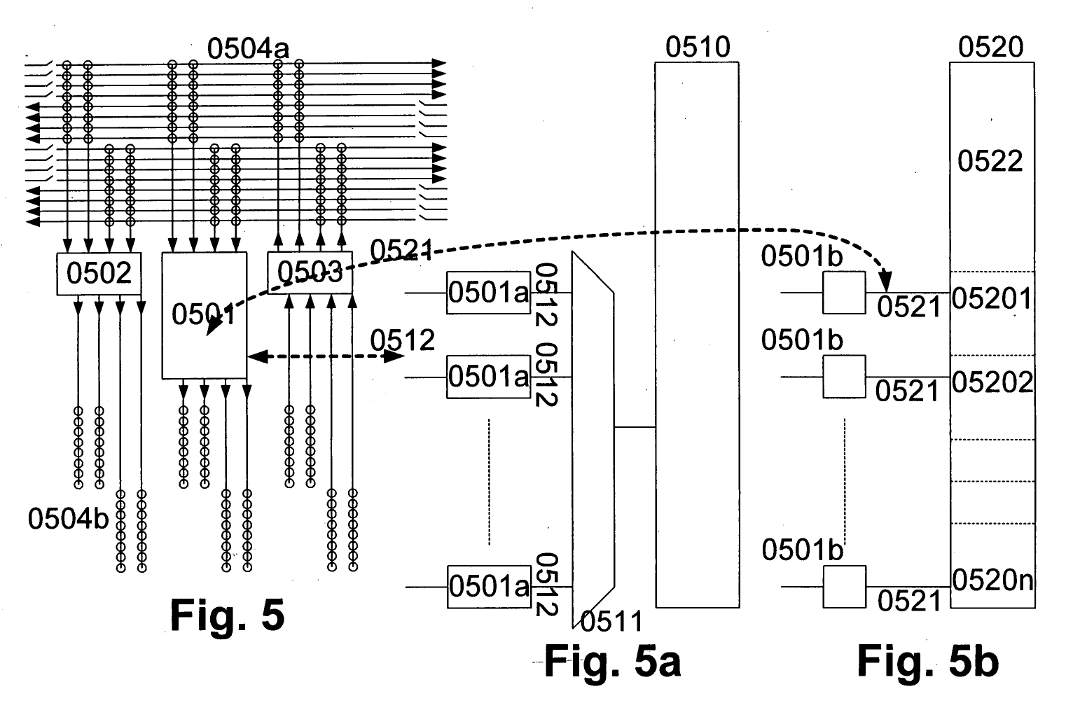

The load/store unit is depicted only schematically and fundamentally in FIG. 3; a preferred embodiment is shown in detail in FIGS. 4 and 5. The VPU data path (0308) is able to transfer data directly with the load/store unit and/or the cache via a bus system 0312; data may be transferred directly between the VPU data path (0308) and peripherals and/or the external memory via another possible data path 0313, depending on the application.

FIG. 4 shows a particularly preferred embodiment of the load/store unit.

According to an important principle of data processing of the VPU architecture, coupled memory blocks which function more or less as a set of registers for data blocks are provided on the array of ALU-PAEs. This method is known from DE 196 54 846, DE 101 39 170, DE 199 26 538, DE 102 06 653. It is advisable here, as described below, to process LOAD and STORE instructions as a configuration within the VPU, which makes interlinking of the VPU with the load/store unit (0401) of the CPU superfluous. In other words, the VPU generates its read and write accesses itself, so a direct connection (0404) to the external memory and/or main memory is appropriate. This is preferably accomplished via a cache (0402), which may be the same as the data cache of the processor. The load/store unit of the processor (0401) accesses the cache directly and in parallel with the VPU (0403) without having a data path for the VPU—in contrast with 0302.

FIG. 5 shows particularly preferred couplings of the VPU to the external memory and/or main memory via a cache.

The simplest method of connection is via an IO terminal of the VPU, as is described, for example, in DE 196 51 075.9-53, DE 196 54 595.1-53, DE 100 50 442.6, DE 102 06 653.1; addresses and data are transferred between the peripherals and/or memory and the VPU by way of this IO terminal. However, direct coupling between the RAM-PAEs and the cache is particularly efficient, as described in DE 196 54 595 and DE 199 26 538. An example given for a reconfigurable data processing element is a PAE constructed from a main data processing unit (0501) which is typically designed as an ALU, RAM, FPGA, IO terminal and two lateral data transfer units (0502, 0503) which in turn may have an ALU structure and/or a register structure. In addition, the array-internal horizontal bus systems 0504a and 0504b belonging to the PAE are also shown.

In FIG. 5a, RAM-PAEs (0501a) which each have their own memory according to DE 196 54 595 and DE 199 26 538 are coupled to a cache 0510 via a multiplexer 0511. Cache controllers and the connecting bus of the cache to the main memory are not shown. The RAM-PAEs preferably have a separate databus (0512) having its own address generators (see also DE 102 06 653) in order to be able to transfer data independently to the cache.

FIG. 5b shows an optimized variant in which 0501b does not denote full-quality RAM-PAEs but instead includes only the bus systems and lateral data transfer units (0502, 0503). Instead of the integrated memory in 0501, only one bus connection (0521) to cache 0520 is implemented. The cache is subdivided into multiple segments 05201, 05202 . . . 0520n, each being assigned to a 0501b and preferably reserved exclusively for this 0501b. The cache thus more or less represents the quantity of all RAM-PAEs of the VPU and the data cache (0522) of the CPU.

The VPU writes its internal (register) data directly into the cache and/or reads the data directly out of the cache. Modified data may be labeled as “dirty,” whereupon the cache controller (not shown here) automatically updates this in the main memory. Write-through methods in which modified data is written directly to the main memory and management of the “dirty data” becomes superfluous are available as an alternative.

Direct coupling according to FIG. 5b is particularly preferred because it is extremely efficient in terms of area and is easy to handle through the VPU because the cache controllers are automatically responsible for the data transfer between the cache—and thus the RAM-PAE—and the main memory.

FIG. 6 shows the coupling of an FPGA structure to a data path considering the example of the VPU architecture.

The main data path of a PAE is 0501. FPGA structures are preferably inserted (0611) directly downstream from the input registers (see PACT02, PACT22) and/or inserted (0612) directly upstream from the output of the data path to the bus system.

One possible FPGA structure is shown in 0610, the structure being based on PACT13, FIG. 35.

The FPGA structure is input into the ALU via a data input (0605) and a data output (0606). In alternation
a) logic elements are arranged in a row (0601) to perform bit-by-bit logic operations (AND, OR, NOT, XOR, etc.) on incoming data. These logic elements may additionally have local bus connections; registers may likewise be provided for data storage in the logic elements;
b) memory elements are arranged in a row (0602) to store data of the logic elements bit by bit. Their function is to represent as needed the chronological uncoupling—i.e., the cyclical behavior—of a sequential program if so required by the compiler. In other words, through these register stages the sequential performance of a program in the form of a pipeline is simulated within 0610.

Horizontal configurable signal networks are provided between elements 0601 and 0602 and are constructed according to the known FPGA networks. These allow horizontal interconnection and transmission of signals.

In addition, a vertical network (0604) may be provided for signal transmission; it is also constructed like the known FPGA networks. Signals may also be transmitted past multiple rows of elements 0601 and 0602 via this network.

Since elements 0601 and 0602 typically already have a number of vertical bypass signal networks, 0604 is only optional and only necessary for a large number of rows.

For coordinating the state machine of the PAE to the particular configured depth of the pipeline in 0610, i.e., the number (NRL) of register stages (0602) configured into it between the input (0605) and the output (0606), a register 0607 is implemented into which NRL is configured. On the basis of this data, the state machine coordinates the generation of the PAE-internal control cycles and in particular also coordinates the handshake signals (PACT02 PACT16, PACT18) for the PAE-external bus systems.

Additional possible FPGA structures are known from Xilinx and Altera, for example, these preferably having a register structure according to 0610.

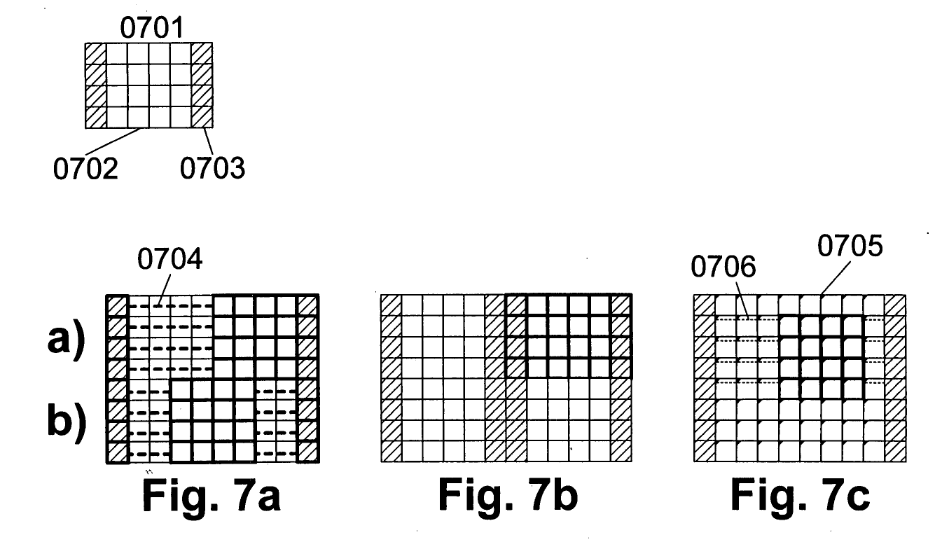

FIG. 7 shows several strategies for achieving code compatibility between VPUs of different sizes:

0701 is an ALU-PAE(0702) RAM-PAE(0703) device which defines a possible “small” VPU. It is assumed in the following discussion that code has been generated for this structure and is now to be processed on other larger VPUs.

A first possible approach is to compile new code for the new destination VPU. This offers the advantage in particular that functions no longer present may be simulated in a new destination VPU by having the compiler instantiate macros for these functions which then simulate the original function. The simulation may be accomplished either through the use of multiple PAEs and/or by using sequencers as described below (e.g., for division, floating point, complex mathematics, etc.) and as known from PACT02 for example. The clear disadvantage of this method is that binary compatibility is lost.

The methods illustrated in FIG. 7 have binary code compatibility.

According to a first simple method, wrapper code is inserted (0704), lengthening the bus systems between a small ALU-PAE array and the RAM-PAEs. The code only contains the configuration for the bus systems and is inserted from a memory into the existing binary code, e.g., at the configuration time and/or at the load time.

The only disadvantage of this method is that it results in a lengthy information transfer time over the lengthened bus systems. This may be disregarded at comparatively low frequencies (FIG. 7a, a)).

FIG. 7a, b) shows a simple optimized variant in which the lengthening of the bus systems has been compensated and thus is less critical in terms of frequency, which halves the runtime for the wrapper bus system compared to FIG. 7a, a).

For higher frequencies, the method according to FIG. 7b may be used; in this method, a larger VPU represents a superset of compatible small VPUs (0701) and the complete structures of 0701 are replicated. This is a simple method of providing direct binary compatibility.

In an optimal method according to FIG. 7c, additional high-speed bus systems have a terminal (0705) at each PAE or each group of PAEs. Such bus systems are known from other patent applications by the present applicant, e.g., PACT07. Data is transferred via terminals 0705 to a high-speed bus system (0706) which then transfers the data in a performance-efficient manner over a great distance. Such high-speed bus systems include, for example, Ethernet, RapidIO, USB, AMBA, RAMBUS and other industry standards.

The connection to the high-speed bus system may be inserted either through a wrapper, as described for FIG. 7a, or architectonically, as already provided for 0701. In this case, at 0701 the connection is simply relayed directly to the adjacent cell and is not used. The hardware abstracts the absence of the bus system here.

Reference was made above to the coupling between a processor and a VPU in general and/or even more generally to a unit that is completely and/or partially and/or rapidly reconfigurable in particular at runtime, i.e., completely in a few clock cycles. This coupling may be supported and/or achieved through the use of certain operating methods and/or through the operation of preceding suitable compiling. Suitable compiling may refer, as necessary, to the hardware in existence in the related art and/or improved according to the present invention.

Parallelizing compilers according to the related art generally use special constructs such as semaphores and/or other methods for synchronization. Technology-specific methods are typically used. Known methods, however, are not suitable for combining functionally specified architectures with the particular time characteristic and imperatively specified algorithms. The methods used therefore offer satisfactory approaches only in specific cases.

Compilers for reconfigurable architectures, in particular reconfigurable processors, generally use macros which have been created specifically for the certain reconfigurable hardware, usually using hardware description languages (e.g., Verilog, VHDL, system C) to create the macros. These macros are then called (instantiated) from the program flow by an ordinary high-level language (e.g., C, C++).

Compilers for parallel computers are known, mapping program parts on multiple processors on a coarsely granular structure, usually based on complete functions or threads. In addition, vectorizing compilers are known, converting extensive linear data processing, e.g., computations of large terms, into a vectorized form and thus permitting computation on superscalar processors and vector processors (e.g., Pentium, Cray).

This patent therefore describes a method for automatic mapping of functionally or imperatively formulated computation specifications onto different target technologies, in particular onto ASICs, reconfigurable modules (FPGAs, DPGAs, VPUS, ChessArray, KressArray, Chameleon, etc., hereinafter referred to collectively by the term VPU), sequential processors (CISC-/RISC-CPUs, DSPs, etc., hereinafter referred to collectively by the term CPU) and parallel processor systems (SMP, MMP, etc.).

VPUs are essentially made up of a multidimensional, homogeneous or inhomogeneous, flat or hierarchical array (PA) of cells (PAEs) capable of executing any functions, in particular logic and/or arithmetic functions (ALU-PAEs) and/or memory functions (RAM-PAEs) and/or network functions. The PAEs are assigned a load unit (CT) which determines the function of the PAEs by configuration and reconfiguration, if necessary.

This method is based on an abstract parallel machine model which, in addition to the finite automata, also integrates imperative problem specifications and permits efficient algorithmic derivation of an implementation on different technologies.

The present invention is a refinement of the compiler technology according to DE 101 39 170.6, which describes in particular the close XPP connection to a processor within its data paths and also describes a compiler particularly suitable for this purpose, which also uses XPP stand-alone systems without snug processor coupling.

At least the following compiler classes are known in the related art: classical compilers, which often generate stack machine code and are suitable for very simple processors that are essentially designed as normal sequencers (see N. Wirth, Compilerbau, Teubner Verlag).

Vectorizing compilers construct largely linear code which is intended to run on special vector computers or highly pipelined processors. These compilers were originally available for vector computers such as CRAY. Modern processors such as Pentium require similar methods because of the long pipeline structure. Since the individual computation steps proceed in a vectorized (pipelined) manner, the code is therefore much more efficient. However, the conditional jump causes problems for the pipeline. Therefore, a jump prediction which assumes a jump destination is advisable. If the assumption is false, however, the entire processing pipeline must be deleted. In other words, each jump is problematical for these compilers and there is no parallel processing in the true sense. Jump predictions and similar mechanisms require a considerable additional complexity in terms of hardware.

Coarsely granular parallel compilers hardly exist in the true sense; the parallelism is typically marked and managed by the programmer or the operating system, e.g., usually on the thread level in the case of MMP computer systems such as various IBM architectures, ASCII Red, etc. A thread is a largely independent program block or an entirely different program. Threads are therefore easy to parallelize on a coarsely granular level. Synchronization and data consistency must be ensured by the programmer and/or operating system. This is complex to program and requires a significant portion of the computation performance of a parallel computer. Furthermore, only a fraction of the parallelism that is actually possible is in fact usable through this coarse parallelization.

Finely granular parallel compilers (e.g., VLIW) attempt to map the parallelism on a finely granular level into VLIW arithmetic units which are able to execute multiple computation operations in parallel in one clock pulse but have a common register set. This limited register set presents a significant problem because it must provide the data for all computation operations. Furthermore, data dependencies and inconsistent read/write operations (LOAD/STORE) make parallelization difficult.

Reconfigurable processors have a large number of independent arithmetic units which are not interconnected by a common register set but instead via buses. Therefore, it is easy to construct vector arithmetic units while parallel operations may also be performed easily. Contrary to traditional register concepts, data dependencies are resolved by the bus connections.

According to a first essential aspect of the present invention, it has been recognized that the concepts of vectorizing compilers and parallelizing compilers (e.g., VLIW) are to be applied simultaneously for a compiler for reconfigurable processors and thus they are to be vectorized and parallelized on a finely granular level.

One essential advantage is that the compiler need not map onto a fixedly predetermined hardware structure but instead the hardware structure is configured in such a way that it is optimally suitable for mapping the particular compiled algorithm.

Description of the Compiler and Data Processing Device Operating Methods According to the Present Invention

Modern processors usually have a set of user-definable instructions (UDI) which are available for hardware expansions and/or special coprocessors and accelerators. If UDIs are not available, processors usually at least have free instructions which have not yet been used and/or special instructions for coprocessors—for the sake of simplicity, all these instructions are referred to collectively below under the heading UDIs.

A quantity of these UDIs may now be used according to one aspect of the present invention to trigger a VPU that has been coupled to the processor as a data path. For example, UDIs may trigger the loading and/or deletion and/or initialization of configurations and specifically a certain UDI may refer to a constant and/or variable configuration.

Configurations are preferably preloaded into a configuration cache which is assigned locally to the VPU and/or preloaded into configuration stacks according to DE 196 51 075.9-53, DE 197 04 728.9 and DE 102 12 621.6-53 from which they may be configured rapidly and executed at runtime on occurrence of a UDI that initializes a configuration. Preloading the configuration may be performed in a configuration manager shared by multiple PAEs or PAs and/or in a local configuration memory on and/or in a PAE, in which case then only the activation need be triggered.

A set of configurations is preferably preloaded. In general, one configuration preferably corresponds to a load UDI. In other words, the load UDIs are each referenced to a configuration. At the same time, it is also possible with a load UDI to refer to a complex configuration arrangement with which very extensive functions that require multiple reloading of the array during execution, a wave reconfiguration, even a repeated wave reconfiguration, etc., are referenceable by an individual UDI.

During operation, configurations may also be replaced by others and the load UDIs may be re-referenced accordingly. A certain load UDI may thus reference a first configuration at a first point in time and at a second point in time it may reference a second configuration that has been newly loaded in the meantime. This may occur by the fact that an entry in a reference list which is to be accessed according to the UDI is altered.

Within the scope of the present invention, a LOAD/STORE machine model, such as that known from RISC processors, for example, is used as the basis for operation of the VPU. Each configuration is understood to be one instruction. The LOAD and STORE configurations are separate from the data processing configurations.

A data processing sequence (LOAD-PROCESS-STORE) thus takes place as follows, for example:

1. LOAD Configuration

Loading the data from an external memory, for example, a ROM of an SOC into which the entire arrangement is integrated and/or from peripherals into the internal memory bank (RAM-PAE, see DE 196 54 846.2-53, DE 100 50 442.6). The configuration includes if necessary address generators and/or access controls to read data out of processor-external memories and/or peripherals and enter it into the RAM-PAEs. The RAM-PAEs may be understood as multidimensional data registers (e.g., vector registers) for operation.

2.—(n−1) Data Processing Configurations

The data processing configurations are configured sequentially into the PA. The data processing preferably takes place exclusively between the RAM-PAEs—which are used as multidimensional data registers—according to a LOAD/STORE (RISC) processor.

n. STORE Configuration

Writing the data from the internal memory banks (RAM-PAEs) to the external memory and/or to the peripherals. The configuration includes address generators and/or access controls to write data from the RAM-PAEs to the processor-external memories and/or peripherals.

Reference is made to PACT11 for the principles of LOAD/STORE operations.

The address generating functions of the LOAD/STORE configurations are optimized so that, for example, in the case of a nonlinear access sequence of the algorithm to external data, the corresponding address patterns are generated by the configurations. The analysis of the algorithms and the creation of the address generators for LOAD/STORE are performed by the compiler.

This operating principle may be illustrated easily by the processing of loops. For example, a VPU having 256-entry-deep RAM-PAEs shall be assumed:

### EXAMPLE a)

for i:=1 to 10,000
1. LOAD-PROCESS-STORE cycle: load and process 1 . . . 256
2. LOAD-PROCESS-STORE cycle: load and process 257 . . . 512
3. LOAD-PROCESS-STORE cycle: load and process 513 . . . 768
. . .

### EXAMPLE b)

for i:=1 to 1000
   for j:=1 to 256
1. LOAD-PROCESS-STORE cycle: load and process
   i=1; j=1 . . . 256
2. LOAD-PROCESS-STORE cycle: load and process
   i=2; j=1 . . . 256
3. LOAD-PROCESS-STORE cycle: load and process
   i=3; j=1 . . . 256
. . .

### EXAMPLE c)

for i:=1 to 1000
   for j:=1 to 512
1. LOAD-PROCESS-STORE cycle: load and process
   i=1; j=1 . . . 256
2. LOAD-PROCESS-STORE cycle: load and process
   i=1; j=257 . . . 512
3. LOAD-PROCESS-STORE cycle: load and process
   i=2; j=1 . . . 256

It is particularly advantageous if each configuration is considered to be atomic, i.e., not interruptable. This therefore solves the problem of having to save the internal data of the PA and the internal status in the event of an interruption. During execution of a configuration, the particular status is written to the RAM-PAEs together with the data.

The disadvantage of this method is that initially no statement is possible regarding the runtime behavior of a configuration. However, this results in disadvantages with respect to the realtime capability and the task change performance.

Therefore, it is proposed as preferred according to the present invention that the runtime of each configuration shall be limited to a certain maximum number of clock pulses. This runtime restriction is not a significant disadvantage because typically an upper limit is already set by the size of the RAM-PAEs and the associated data volume. Logically, the size of the RAM-PAEs corresponds to the maximum number of data processing clock pulses of a configuration, so that a typical configuration is limited to a few hundred to one thousand clock pulses. Multithreading/hyperthreading and realtime methods may be implemented together with a VPU by this restriction.

The runtime of configurations is preferably monitored by a tracking counter and/or watchdog, e.g., a counter (which runs with the clock pulse or some other signal). If the time is exceeded, the watchdog triggers an interrupt and/or trap which may be understood and treated like an “illegal opcode” trap of processors.

Alternatively, a restriction may be introduced to reduce reconfiguration processes and to increase performance:

Running configurations may retrigger the watchdog and may thus proceed more slowly without having to be changed. A retrigger is allowed only if the algorithm has reached a “safe” state (synchronization point in time) at which all data and states have been written to the RAM-PAEs and an interruption is allowed according to the algorithm. The disadvantage of this expansion is that a configuration could run in a deadlock within the scope of its data processing but continues to retrigger the watchdog properly and thus does not terminate the configuration.

A blockade of the VPU resource by such a zombie configuration may be prevented by the fact that retriggering of the watchdog may be suppressed by a task change and thus the configuration is changed at the next synchronization point in time or after a predetermined number of synchronization times. Then although the task having the zombie is no longer terminated, the overall system continues to run properly.

Optionally multithreading and/or hyperthreading may be introduced as an additional method for the machine model and/or the processor. All VPU routines, i.e., their configurations, are preferably considered then as a separate thread. Since the VPU is coupled to the processor as the arithmetic unit, it may be considered as a resource for the threads. The scheduler implemented for multithreading according to the related art (see also P 42 21 278.2-09) automatically distributes threads programmed for VPUs (VPU threads) to them. In other words, the scheduler automatically distributes the different tasks within the processor.

This results in another level of parallelism. Both pure processor threads and VPU threads are processed in parallel and may be managed automatically by the scheduler without any particular additional measures.

This method is particularly efficient when the compiler breaks down programs into multiple threads that are processable in parallel, as is preferred and is usually possible, thereby dividing all VPU program sections into individual VPU threads.

To support a rapid task change, in particular including realtime systems, multiple VPU data paths, each of which is considered as its own independent resource, may be implemented. At the same time, this also increases the degree of parallelism because multiple VPU data paths may be used in parallel.

To support realtime systems in particular, certain VPU resources may be reserved for interrupt routines so that for a response to an incoming interrupt it is not necessary to wait for termination of the atomic non-interruptable configurations. Alternatively, VPU resources may be blocked for interrupt routines, i.e., no interrupt routine is able to use a VPU resource and/or contain a corresponding thread. Thus rapid interrupt response times are also ensured. Since typically no VPU-performing algorithms occur within interrupt routines, or only very few, this method is preferred. If the interrupt results in a task change, the VPU resource may be terminated in the meantime. Sufficient time is usually available within the context of the task change.

One problem occurring in task changes may be that the LOAD-PROCESS-STORE cycle described previously must be interrupted without having to write all data and/or status information from the RAM-PAEs to the external RAMs and/or peripherals.

According to ordinary processors (e.g., RISC LOAD/STORE machines), a PUSH configuration is now introduced; it may be inserted between the configurations of the LOAD-PROCESS-STORE cycle, e.g., in a task change. PUSH saves the internal memory contents of the RAM-PAEs to external memories, e.g., to a stack; external here means, for example, external to the PA or a PA part but it may also refer to peripherals, etc. To this extent PUSH thus corresponds to the method of traditional processors in its principles. After execution of the PUSH operation, the task may be changed, i.e., the instantaneous LOAD-PROCESS-STORE cycle may be terminated and a LOAD-PROCESS-STORE cycle of the next task may be executed. The terminated LOAD-PROCESS-STORE cycle is incremented again after a subsequent task change to the corresponding task in the configuration (KATS) which follows after the last configuration implemented. To do so, a POP configuration is implemented before the KATS configuration and thus the POP configuration in turn loads the data for the RAM-PAEs from the external memories, e.g., the stack, according to the methods used with known processors.

An expanded version of the RAM-PAEs according to DE 196 54 595.1-53 and DE 199 26 538.0 has been recognized as particularly efficient for this purpose; in this version the RAM-PAEs have direct access to a cache (DE 199 26 538.0) (case A) or may be regarded as special slices within a cache and/or may be cached directly (DE 196 54 595.1-53) (case B).

Due to the direct access of the RAM-PAEs to a cache or direct implementation of the RAM-PAEs in a cache, the memory contents may be exchanged rapidly and easily in a task change.

Case A: the RAM-PAE contents are written to the cache and loaded again out of it via a preferably separate and independent bus. A cache controller according to the related art is responsible for managing the cache. Only the RAM-PAEs that have been modified in comparison with the original content need be written into the cache. A “dirty” flag for the RAM-PAEs may be inserted here, indicating whether a RAM-PAE has been written and modified. It should be pointed out that corresponding hardware means may be provided for implementation here.

Case B: the RAM-PAEs are directly in the cache and are labeled there as special memory locations which are not affected by the normal data transfers between processor and memory. In a task change, other cache sections are referenced. Modified RAM-PAEs may be labeled as dirty. Management of the cache is handled by the cache controller.

In application of cases A and/or B, a write-through method may yield considerable advantages in terms of speed, depending on the application. The data of the RAM-PAEs and/or caches may be written through directly to the external memory with each write access by the VPU. Thus the RAM-PAE and/or the cache content remains clean at any point in time with regard to the external memory (and/or cache). This eliminates the need for updating the RAM-PAEs with respect to the cache and/or the cache with respect to the external memory with each task change.

PUSH and POP configurations may be omitted when using such methods because the data transfers for the context switches are executed by the hardware.

By restricting the runtime of configurations and supporting rapid task changes, the realtime capability of a VPU-supported processor is ensured.

The LOAD-PROCESS-STORE cycle allows a particularly efficient method for debugging the program code according to DE 101 42 904.5. If, as is preferred, each configuration is considered to be atomic and thus uninterruptable, then the data and/or states relevant for debugging are essentially in the RAM-PAEs after the end of processing of a configuration. The debugger thus need only access the RAM-PAEs to obtain all the essential data and/or states.

Thus the granularity of a configuration is adequately debuggable. If details regarding the process configurations must be debugged, according to DE 101 42 904.5 a mixed mode debugger is used with which the RAM-PAE contents are read before and after a configuration and the configuration itself is checked by a simulator which simulates processing of the configuration.

If the simulation results do not match the memory contents of the RAM-PAEs after the processing of the configuration processed on the VPU, then the simulator is not consistent with the hardware and there is either a hardware defect or a simulator error which must then be checked by the manufacturer of the hardware and/or the simulation software.

It should be pointed out in particular that the limitation of the runtime of a configuration to the maximum number of cycles particularly promotes the use of mixed-mode debuggers because then only a relatively small number of cycles need be simulated.

Due to the method of atomic configurations described here, the setting of breakpoints is also simplified because monitoring of data after the occurrence of a breakpoint condition is necessary only on the RAM-PAEs, so that only they need be equipped with breakpoint registers and comparators.

In an expanded hardware variant, the PAEs may have sequencers according to DE 196 51 075.9-53 (FIGS. 17, 18, 21) and/or DE 199 26 538.0, with entries into the configuration stack (see DE 197 04 728.9, DE 100 28 397.7, DE 102 12 621.6-53) being used as code memories for a sequencer, for example.

It has been recognized that such sequencers are usually very difficult for compilers to control and use. Therefore pseudocodes are preferably made available for these sequencers with compiler-generated assembler instructions being mapped on them. For example, it is inefficient to provide opcodes for division, roots, exponents, geometric operations, complex mathematics, floating point instructions, etc. in the hardware. Therefore, such instructions are implemented as multicyclic sequencer routines, with the compiler instantiating such macros by the assembler as needed.

Sequencers are particularly interesting, for example, for applications in which matrix computations must be performed frequently. In these cases, complete matrix operations such as a 2×2 matrix multiplication may be compiled as macros and made available for the sequencers.

If in an expanded architecture variant, FPGA units are implemented in the ALU-PAES, then the compiler has the following option:

When logic operations occur within the program to be translated by the compiler, e.g., &, |, >>, <<, etc., the compiler generates a logic function corresponding to the operation for the FPGA units within the ALU-PAE. To this extent the compiler is able to ascertain that the function does not have any time dependencies with respect to its input and output data, and the insertion of register stages after the function may be omitted.

If a time independence is not definitely ascertainable, then registers are configured into the FPGA unit according to the function, resulting in a delay by one clock pulse and thus triggering the synchronization.

On insertion of registers, the number of inserted register stages per FPGA unit on configuration of the generated configuration on the VPU is written into a delay register which triggers the state machine of the PAE. The state machine may therefore adapt the management of the handshake protocols to the additionally occurring pipeline stage.

After a reset or a reconfiguration signal (e.g., Reconfig) (see PACT08, PACT16) the FPGA units are switched to neutral, i.e., they allow the input data to pass through to the output without modification. Unused FPGA units thus do not need any configuration information.

All the PACT patent applications cited here are herewith incorporated fully for disclosure purposes.

Any other embodiments and combinations of the inventions referenced here are possible and will be obvious to those skilled in the art.

What is claimed is:

1. A method for operation and/or preparing the operation of a traditional processor, in particular a sequential processor, and a reconfigurable field of data processing units, in particular a runtime-reconfigurable field of data processing units,
in which the traditional processor processes defined instructions in a set of a plurality of predefined and non-predefined instructions
and triggers data processing unit field reconfigurations, wherein the data processing unit field reconfigurations and/or data processing unit field partial reconfigurations and/or preload reconfigurations are triggered and/or induced by the processor in response to the occurrence of instructions not predefined by the processor.

2. The method as recited in the preceding claim,
wherein a plurality of user-defined instructions, not predefined by the processor, are provided, different data processing unit field reconfigurations being induced in response to different user-defined instructions.

3. The method as recited in one of the preceding claims,
wherein referencing to data processing unit field reconfigurations is provided to support the management of the data processing unit field reconfigurations and in particular to facilitate the change in allocation of configurations to be loaded to user-defined instructions.

4. The method as recited in one of the preceding claims,
wherein a plurality of configurations are loaded simultaneously, in particular preloaded for an even possible and/or anticipated execution.

5. The method as recited in one of the preceding claims,
wherein load/store instructions having an integrated status query (load_rdy, store_ack) are provided within the instruction set of the CPU and/or of the traditional processor, in particular a sequential processor, these instructions being used in particular to control write operations and/or read operations.

6. The method as recited in one of the preceding claims,
wherein configurations to be executed on the VPU are selected by an instruction decoder (0105) of the CPU and/or the other traditional processor, in particular a sequential processor, this instruction decoder recognizing certain instructions, if any are present there, intended for the VPU and preferably triggering its configuration unit (0106) in such a way that it loads the corresponding configurations from a memory (0107) assigned to the CT, in particular a memory shared with the CPU or optionally the same as the working memory of the CPU, into the configurable data processing unit field, which is formed in particular as an array of PAEs (PA, 0108).

7. The method as recited in particular in the preceding claim for operation and/or for preparing the operation of a traditional processor, in particular a sequential processor, and a reconfigurable field of data processing units, in particular a runtime-reconfigurable field of data processing units,
wherein the traditional processor, in particular a sequential processor, is operated at least temporarily in a multithreading operation.

8. The method as recited in one of the preceding claims,
wherein an application is broken down into a plurality of threads in preparation for operation, in particular by a compiler.

9. The method as recited in one of the preceding claims,
wherein interrupt routines, in particular those routines free of code for the reconfigurable field of data processing units, are provided for the traditional processor, in particular a sequential processor.

10. The method as recited in one of the preceding claims,
wherein multiple VPU data paths are implemented, each being addressed as a stand-alone resource and/or utilized in parallel.

11. The method as recited in one of the preceding claims,
wherein operations parallelizable with difficulty, in particular divisions, roots, exponents, geometric operations, complex mathematical operations and/or floating-point computations are shifted to the reconfigurable field of data processing units and implemented in the form of multicyclic sequencer routines on the reconfigurable field of data processing units, in particular by instantiation of macros.

12. The method as recited in one of the preceding claims,
wherein the data accesses are re-sorted before operation, in particular in compiling, such that an improved, preferably extensive, in particular at least essentially maximal independence exists between the accesses via the data path of the CPU and the VPU to compensate for runtime differences between the CPU data path and the VPU data path, and/or in particular if the runtime difference remains too great, NOP cycles are inserted by compiler and/or wait cycles are generated in the CPU data path by the hardware until the required data is available for further processing by the VPU and in particular has been written to the register or is expected, this being indicated in particular by an additional bit being set in the register.

13. The method as recited in one of the preceding claims,
wherein for operation of the reconfigurable field of data processing units, LOAD and/or STORE configurations are provided, in particular a LOAD configuration being such that data is loaded from an external memory to an internal memory, for example, to which end address generators and/or access controls in particular are configured to read data from processor-external memories and/or peripherals and write the data into the internal memories, in particular RAM-PAES, and in particular in such a way as during operation as a multidimensional data register (e.g., vector register) and/or additionally in particular data being written from the internal memories (RAM-PAEs) to the external memory and/or peripherals, to which end address generators and/or access controls in particular are configured, in particular at least partial address generating functions being optimized, so that the corresponding address patterns are generated by the configurations in the case of a nonlinear access sequence of the algorithm to external data.

14. The method as recited in one of the preceding claims,
wherein debugging is performed in preparation for operation, in particular using LOAD and/or STORE configurations, in particular by execution of a LOAD-PROCESS-STORE cycle, whereby data and/or states relevant for debugging are in the RAM-PAEs after the end of processing of a configuration and are accessed for debugging, in particular runtime-limited and/or watchdog-monitored configurations or configuration atoms being debugged.

15. The method as recited in the preceding claim,
wherein the behavior of the system is simulated in preparation for operation.

16. The method as recited in one of the preceding claims,
wherein at least temporarily a PUSH configuration is configured onto the field, in particular is inserted when there is a task change and/or between the configurations of the LOAD-PROCESS-STORE cycle and saves the internal memory contents of the field-internal memories, in particular RAM-PAES, to an external memory, in particular to a stack; preferably after the PUSH configuration processing, processing is switched to another task, i.e., the current LOAD-PROCESS-STORE cycle is terminable and a LOAD-PROCESS-STORE cycle of the next task is executable and/or a POP configuration is at least temporarily configured onto the field to load data from the external memories like a stack.

17. The method as recited in one of the preceding claims,
wherein a scheduler is provided for use of multithreading and/or hyperthreading technologies, distributing the applications and/or application parts (threads) among the resources within the processor in a finely granular manner.

18. The method as recited in particular in one of the preceding claims for operation and/or for preparing the operation of a traditional processor, in particular a sequential processor, and a reconfigurable field of data processing units, in particular a runtime reconfigurable field of data processing units,
wherein a configuration to be loaded is handled and/or considered as being uninterruptable.

19. The method as recited in particular in one of the preceding claims for operation and/or for preparing the operation of a traditional processor, in particular a sequential processor, and a reconfigurable field of data processing units, in particular a runtime-reconfigurable field of data processing units in which the traditional processor processes defined instructions in a set of a plurality of predefined and unpredefined instructions and triggers data processing unit field reconfigurations,
wherein each configuration or, equivalently in particular in preloading a plurality of configuration groups for purposes of alternative and/or briefly sequential execution, each configuration group is limited to a certain maximum number of runtime cycles.

20. The method as recited in the preceding claim,
wherein the maximum number is increasable on the configuration end, in particular by retriggering and/or resetting a watchdog tracking counter.

21. The method as recited in the preceding claim,
wherein an increase in the maximum number at the configuration end, which is possible per se, is suppressible in particular in and/or by task switching and/or a maximal count-incrementing frequency tracking counter is provided for limiting the number of times the maximum number is increased by a single configuration.

22. The method as recited in one of the preceding claims,
wherein a processor exception signal is generated in response to the actual or presumed occurrence of a non-terminating configuration detected in particular by a tracking counter.

23. The method as recited in particular in one of the preceding claims for operation and/or for preparing the operation of a traditional processor, in particular a sequential processor, and a reconfigurable field of data processing units, in particular a runtime-reconfigurable field of data processing units,
wherein a runtime estimate is performed for the configuration execution to permit operation of the processor that is adequate for the runtime.

24. A method for operation and/or for preparing the operation of a traditional processor, in particular a sequential processor, and a reconfigurable field of data processing units, in particular a runtime-reconfigurable field of data processing units, in which data is exchanged between processor and data processing unit field,
wherein data from the data processing unit field is stored in a processor cache and/or is obtained therefrom.

25. The method as recited in the preceding claim,
wherein cache region labeling is provided for identifying cache regions that are considered to be “dirty.”

26. The method as recited in the preceding claim,
wherein a hidden write back, in particular induced by the cache controller, is provided in particular for keeping the cache clean.

27. A device in particular for executing a method as recited in one of the preceding claims,
wherein the processor field or a processor field formed at least partially by reconfigurable units has FPGA-like circuit areas, in particular as separate reconfigurable units and/or as a data path or part of a data path between coarsely granularly reconfigurable units and/or IO terminal areas, in particular ALU units and/or as part of a processor field cell containing at least one ALU unit.

28. The device as recited in the preceding claim,
wherein FPGA-like circuit areas are provided in the data path between coarsely granularly reconfigurable units and/or IO terminals areas, and, in the case of nonuse and/or in the reset state, allow a pass-through with no modification of the data.

29. The device as recited in one of the preceding device claims,
wherein a hardware-implemented scheduler is provided for use of multithreading and/or hyperthreading technologies and is designed to distribute applications and/or application parts (threads) in a finely granular manner among resources within the processor.
